(19) United States
(12) Patent Application Publication
(10) Pub. No.: US 2025/0353490 A1
(43) Pub. Date: Nov. 20, 2025

(54) DETECTION OF LOSS-OF-CONTROL OBJECTS IN AUTOMOTIVE ENVIRONMENTS

(71) Applicant: Waymo LLC, Mountain View, CA (US)

(72) Inventors: Kevin Sheu, San Jose, CA (US); Clayton Gregory Kunz, Mill Valley, CA (US); Kaifei Chen, Sunnyvale, CA (US); Sy Olson, Oakland, CA (US)

(21) Appl. No.: 18/666,071

(22) Filed: May 16, 2024

(51) Int. Cl. B60W 30/09; B60W 30/095; B60W 60/00

(52) U.S. Cl. CPC B60W 30/09; B60W 30/0956; B60W 60/0015; B60W 2420/403; B60W 2420/408; B60W 2554/402; B60W 2554/4044; B60W 2556/20

(57) ABSTRACT

The disclosed systems and techniques are directed to identifying and responding to presence of objects in driving environments that are at risk of loss of control of their driving trajectories. The techniques include collecting, using a sensing system of a vehicle, sensing data for an environment of an autonomous vehicle. The techniques further include identifying a heading direction of an object in the environment, based at least on the sensing data. The techniques further include determining that the object is at risk of loss of control of a driving trajectory, based at least on a difference between the heading direction and a direction of travel of the object, and causing a control system of the autonomous vehicle to perform an avoidance action.

### TECHNICAL FIELD

The instant specification generally relates to autonomous vehicles. More specifically, the instant specification relates to automated detection of objects in automotive environments that are at risk of losing control of their motion.

### BACKGROUND

An autonomous (fully and partially self-driving) vehicle (AV) operates by sensing an outside environment with various electromagnetic (e.g., radar and optical) and non-electromagnetic (e.g., audio and humidity) sensors. Some autonomous vehicles chart a driving path through the environment based on the sensed data. The driving path can be determined based on Global Positioning System (GPS) data and road map data. While the GPS and the road map data can provide information about static aspects of the environment (buildings, street layouts, road closures, etc.), dynamic information (such as information about other vehicles, pedestrians, street lights, etc.) is obtained from contemporaneously collected sensing data. Precision and safety of the driving path and of the speed regime selected by the autonomous vehicle depend on timely and accurate identification of various objects present in the outside environment and on the ability of a driving algorithm to process the information about the environment and to provide correct instructions to the vehicle controls and the drivetrain.

### BRIEF DESCRIPTION OF THE DRAWINGS

The present disclosure is illustrated by way of examples, and not by way of limitation, and can be more fully understood with references to the following detailed description when considered in connection with the figures, in which:

FIG. 1 is a diagram illustrating components of an example autonomous vehicle (AV) capable of detection of loss of control (LoC) of objects in driving environments, in accordance with some implementations of the present disclosure.

FIG. 2A is a diagram illustrating a first stage of an example architecture of a part of a vehicle's perception system capable of identifying objects in driving environments that are at risk of LoC, in accordance with some implementations of the present disclosure.

FIG. 2B is a diagram illustrating a second stage of the example architecture of the part of the vehicle's perception system capable of identifying objects in driving environments that are at risk of LoC, in accordance with some implementations of the present disclosure.

FIGS. 3A-3B depict schematically a pattern of normal motion of an object and a pattern of motion that places an object at risk of a loss of control, in accordance with some implementations of the present disclosure.

FIGS. 4A-4B illustrate schematically a threshold yaw angle dependence on a speed of an object that can be used for detection of loss of control in driving environments, in accordance with some implementations of the present disclosure.

FIG. 5 illustrates an example method of identifying and responding to presence of objects in driving environments that are at risk of loss of control of their driving trajectories, in accordance with some implementations of the present disclosure.

FIG. 6 depicts a block diagram of an example computer device capable of identifying and responding to presence of objects in driving environments that are at risk of loss of control of their driving trajectories, in accordance with some implementations of the present disclosure.

### SUMMARY

In one implementation, disclosed is a system that includes a sensing system of an autonomous vehicle and a perception system of the autonomous vehicle. The sensing system is configured to collect sensing data for an environment of the autonomous vehicle. The perception system is configured to identify a heading direction of an object in the environment, based at least on the sensing data. The perception system is further configured to determine that the object is at risk of loss of control of a driving trajectory, based at least on a difference between the heading direction and a direction of travel of the object, and cause a control system of the autonomous vehicle to perform an avoidance action.

In another implementation, disclosed is a method that includes collecting, using a sensing system of an autonomous vehicle, sensing data for an environment of the autonomous vehicle and identifying a heading direction of an object in the environment, based at least on the sensing data. The method further includes determining that the object is at risk of loss of control of a driving trajectory, based at least on a difference between the heading direction and a direction of travel of the object, causing a control system of the autonomous vehicle to perform an avoidance action.

In yet another implementation, disclosed is an autonomous vehicle that includes a sensing system, a perception system, and a driving control system. The sensing system is configured to collect sensing data for an environment of the autonomous vehicle. The perception system is configured to identify a heading direction of an object in the environment, based at least on the sensing data. The perception system is further configured to determine that the object is at risk of loss of control of a driving trajectory, based at least on a difference between the heading direction and a direction of travel of the object, and select an avoidance action. The driving control system is configured to perform the selected avoidance action.

### DETAILED DESCRIPTION

An autonomous vehicle or a vehicle deploying various driver assistance features can use multiple sensor modalities to facilitate detection and identification of objects in the driving environments and tracking trajectories of these objects. Sensors can include radio detection and ranging (radar) sensors, light detection and ranging (lidar) sensors, multiple digital cameras, sonars, geolocation sensors, positional sensors, and the like. Different types of sensors can provide different and complementary benefits. For example, radars and lidars emit electromagnetic signals (radio signals or optical signals) that reflect from the objects and carry back information about distances to the objects (e.g., from the time of flight of the signals) and velocities of the objects (e.g., from the Doppler shift of the frequencies of the reflected signals). Radars and lidars can scan an entire 360-degree view by using a series of consecutive sensing frames. Sensing frames can include numerous reflections covering the outside environment in a dense grid of return points. Each return point can be associated with the distance to the corresponding reflecting object and a radial velocity (a component of the velocity along the line of sight) of the reflecting object.

Lidars, by virtue of their sub-micron optical wavelengths, have high spatial resolution, which allows obtaining many closely spaced return points from the same object. This enables accurate detection and tracking of objects once the objects are within the reach of lidar sensors. Lidars have an operating range of 150-350 m, depending on a specific lidar model, with higher ranges typically achieved by more powerful and expensive systems.

Radar sensors are inexpensive, require less maintenance than lidar sensors, have a large working range of distances, and have a good tolerance of adverse weather conditions. As a result of much longer (radio) wavelengths used by radars, resolution of radar data is much lower than that of lidars. In particular, while radars are capable of accurate determination of velocities of objects moving with not too small velocities (relative to the radar receiver), detecting accurate locations of objects can be often problematic.

Cameras (e.g., photographic or video cameras) can acquire high resolution images at both shorter distances (where lidars operate) and longer distances (where lidars do not reach. Cameras capture two-dimensional projections of the three-dimensional outside space onto an image plane (or some other non-planar imaging surface). Cameras have a longer, than lidars, operating range but determine positions of objects with a higher error along the radial direction compared with the lateral directions.

Camera and lidar images (as well as radar images, in some applications) can be processed by various object detection models, including deep learning neural network models. Such models can determine positions and orientations of objects and evolution of the positions and orientations of the objects with time. These models can further classify the object by type (e.g., truck, car, school bus, motorcyclist, pedestrian, and/or the like), manufacturer, model, and/or the like.

Driving environments are very fluid and prone to creating unexpected high-risk situations, when the normal traffic flow is disrupted by a vehicle performing an unexpected maneuver, two or more vehicles moving close to each other, a pedestrian or an animal moving on or across the roadway, and/or the like. In many instances, a precursor of a high-risk situation is an object, e.g., a vehicle, with a driving pattern indicative of an imminent loss of control. For example, while aggressive steering is unlikely to result in a loss of control when a vehicle is moving with a relatively low speed, e.g., 20-25 mph, a similar style of steering is much more likely to result in a loss of tire traction (and a subsequent crash) at highway, e.g., 60-65 mph, speeds. For example, a common pattern of a highway crash involves a vehicle that oversteers (e.g., in response to an unexpected turn of the roadway) into a turn, attempts to correct the oversteer by turning the wheels in the opposite direction (e.g., towards the outside of the turn), instead overcompensating, and so on, causing the vehicle to enter a pattern of motion in which the heading of the vehicle swings around the direction of travel with an increasing amplitude until the front or rear wheels of the vehicle lose traction and the vehicle spins, leaves the roadways, rolls over, and/or moves in some other way that endangers other vehicles and/or objects in the driving environment.

A vehicle that loses control of its driving trajectory can move in a very unpredictable fashion. For example, a spinning vehicle can quickly veer across multiple lanes. This can occur in either direction (e.g., from left-to-right or right-to-left) depending on a specific moment when traction is lost. Because, a spinning object slows down dramatically along the direction of its travel, other road users traveling within a certain distance (whose specific value depends on the speed of traffic) from the object that loses control (referred to as the loss-of-control object, or LoC object, herein) can crash into the LoC object. Detection of driving situations that can result in LoC is important for road safety, including safety of autonomous driving vehicles and vehicles equipped with driver-assist technology. Automated detection of possible LoC situations is challenging since collecting significant observations related to occurrence of such situations is difficult (in view of a relatively low percentage of driving missions in which LoC is observed).

Aspects and implementations of the instant disclosure address these and other challenges of the existing object detection and tracking technology by providing for systems and techniques that efficiently and timely identify objects in driving environments that are at risk of a loss of control and take appropriate response actions to eliminate or reduce the risk of colliding with such objects. In some implementations, the disclosed techniques include an object detection and tracking system that uses sensing data (e.g., lidar, radar, camera data, and/or the like) to identify various objects in the environment—vehicles, pedestrians, inanimate objects, etc.—and determine the state of the motion of the identified objects, e.g., coordinates, velocity, and/or the like. A trained heading detection model (HDM) can use sensing data associated with an individual object to determine a heading direction \vec{h} for an object. Under normal driving conditions, the heading direction \vec{h} can be the same as (or deviate insignificantly) from the direction of travel \vec{m} prescribed by the roadway layout OSH, e.g., a direction of the lane in which the object is staying. The roadway layout and the direction of travel \vec{m} can be determined based on available static road map data and/or dynamic lane information obtained using sensing data (e.g., lidar and/or camera data). Under some conditions, e.g., normal lane changes by a vehicle, the heading direction \vec{h} can differ from the direction of travel \vec{m} by some yaw angle θ. The value of the yaw angle θ can be smaller for normal lane changes and larger for more aggressive lane changes and/or other maneuvers. It should be understood that the direction of travel \vec{m} and heading direction \vec{h} can both be different from an instantaneous direction of motion (direction of the vehicle's velocity \vec{v} of the vehicle), on some occasions. For example, when a vehicle moves from an inside lane to an outside lane too fast and experiences a skid toward the outside lane, the angle between the direction of velocity \vec{v} and the direction of travel \vec{m} (e.g., the lane direction) can be larger than the angle between the heading direction \vec{h} and the direction of travel \vec{m}.

An LoC detection module can evaluate the determined yaw angle θ in view of other factors and determine whether the driving style of the object places the object at a risk of LoC. In some implementations, the LoC module can access a stored a dependence of a threshold yaw angle θ_{T}(V) on a speed (value of the velocity) of the object. For yaw angles that are less than the threshold yaw angle, θ<θ_{T}(V), LoC detection module can determine that the object is not likely to lose control of its driving trajectory. On the other hand, yaw angles that exceed the threshold yaw angle, θ>θ_{T}(V), can be associated with a possible LoC. In some implementations, a dependence of the threshold yaw angle θ_{T}(V), on speed V can be determined using field testing performed with the assistance of an expert driver taking a test vehicle of a particular type on a test run. The field testing can include recording various dynamic information, including a direction of travel and the heading angle at multiple times for those test drives identified by the expert driver as bringing the test vehicle(s) close to the limits of driver's control. The data accessible to the LoC module can include multiple sets characterizing the threshold yaw angle vs. speed dependence, {θ_{T}(V; T, C)}, e.g., collected for different types T of vehicles (e.g., passenger car, sport-utility vehicle, bus, truck, motorcycle, and so on), road condition C (e.g., dry pavement, wet pavement, unpaved road, and so on).

Having determined that a particular object is at risk of LoC, a behavior prediction system of a vehicle can run a simulation that presumes that at the next moment of time, the object is going to lose control of its motion and move according to one of possible patterns, e.g., wing across the roadway (leftward and/or rightward), slow down significantly, or perform some combination of such motions. The behavior prediction system can select a worst-case path of the object (e.g., a trajectory that passes at the closest distance from the vehicle) and can generate a trajectory for the vehicle that avoids the worst-case path, e.g., by braking, nudging (moving in a lateral direction within the lane of travel), changing lanes, accelerating (e.g., when the object is located on a side of the vehicle), and/or performing any combination thereof.

Numerous other implementations are disclosed herein. The advantages of the disclosed techniques and systems include, but are not limited to, a timely and efficient identification of objects that are likely to lose control of their trajectories and become a source of hazard for other road users, and taking appropriate defensive actions to reduce the risk of an accident.

In those instances where description of implementations refers to autonomous vehicles, it should be understood that similar techniques can be used in various driver assistance systems that do not rise to the level of fully autonomous driving systems. More specifically, disclosed techniques can be used in Level 2 driver assistance systems that implement steering, braking, acceleration, lane centering, adaptive cruise control, etc., as well as other driver support. Likewise, the disclosed techniques can be used in Level 3 driving assistance systems capable of autonomous driving under limited (e.g., highway) conditions. In such systems, fast and accurate detection and tracking of objects can be used to inform the driver of the approaching vehicles and/or other objects, with the driver making the ultimate driving decisions (e.g., in Level 2 systems), or to make certain driving decisions (e.g., in Level 3 systems), such as reducing speed, changing lanes, etc., without requesting driver's feedback.

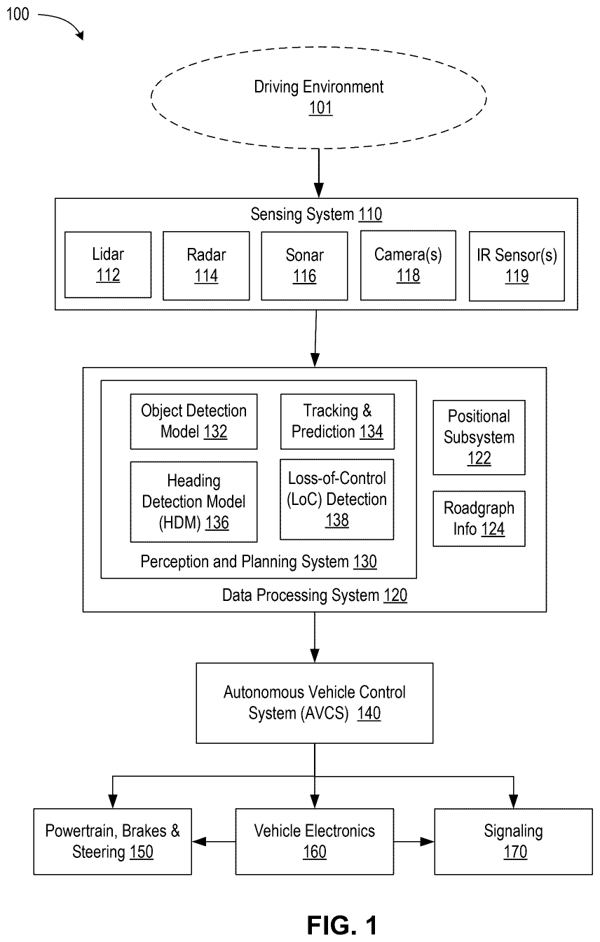

FIG. 1 is a diagram illustrating components of an example autonomous vehicle (AV) 100 capable of detection of loss of control (LoC) of objects in driving environments, in accordance with some implementations of the present disclosure. Autonomous vehicles can include motor vehicles (cars, trucks, buses, motorcycles, all-terrain vehicles, recreational vehicles, any specialized farming or construction vehicles, and the like), aircraft (planes, helicopters, drones, and the like), naval vehicles (ships, boats, yachts, submarines, and the like), or any other self-propelled vehicles (e.g., robots, factory or warehouse robotic vehicles, sidewalk delivery robotic vehicles, etc.) capable of being operated in a self-driving mode (without a human input or with a reduced human input).

A driving environment 101 can include any objects (animated or non-animated) located outside the AV, such as roadways, buildings, trees, bushes, sidewalks, bridges, mountains, other vehicles, pedestrians, and so on. The driving environment 101 can be urban, suburban, rural, and so on. In some implementations, the driving environment 101 can be an off-road environment (e.g., farming or other agricultural land). In some implementations, the driving environment can be an indoor environment, e.g., the environment of an industrial plant, a shipping warehouse, a hazardous area of a building, and so on. In some implementations, the driving environment 101 can be substantially flat, with various objects moving parallel to a surface (e.g., parallel to the surface of Earth). In other implementations, the driving environment can be three-dimensional and can include objects that are capable of moving along all three directions (e.g., balloons, leaves, etc.). Hereinafter, the term “driving environment” should be understood to include all environments in which an autonomous motion of self-propelled vehicles can occur. For example, “driving environment” can include any possible flying environment of an aircraft or a marine environment of a naval vessel. The objects of the driving environment 101 can be located at any distance from the AV, from close distances of several feet (or less) to several miles (or more).

As described herein, in a semi-autonomous or partially autonomous driving mode, even though the vehicle assists with one or more driving operations (e.g., steering, braking and/or accelerating to perform lane centering, adaptive cruise control, advanced driver assistance systems (ADAS), or emergency braking), the human driver is expected to be situationally aware of the vehicle's surroundings and supervise the assisted driving operations. In such driving mode(s), even though the vehicle may perform all driving tasks in certain situations, the human driver is expected to be responsible for taking control as needed.

Although, for brevity and conciseness, various systems and methods may be described below in conjunction with autonomous vehicles, similar techniques can be used in various driver assistance systems that do not rise to the level of fully autonomous driving systems. In the United States, the Society of Automotive Engineers (SAE) have defined different levels of automated driving operations to indicate how much, or how little, a vehicle controls the driving, although different organizations, in the United States or in other countries, may categorize the levels differently. More specifically, disclosed systems and methods can be used in SAE Level 2 (L2) driver assistance systems that implement steering, braking, acceleration, lane centering, adaptive cruise control, etc., as well as other driver support. The disclosed systems and methods can be used in SAE Level 3 (L3) driving assistance systems capable of autonomous driving under limited (e.g., highway) conditions. Likewise, the disclosed systems and methods can be used in vehicles that use SAE Level 4 (L4) self-driving systems that operate autonomously under most regular driving situations and require only occasional attention of the human operator. In all such driving assistance systems, accurate assessment of the driving environment can be performed automatically without a driver input or control (e.g., while the vehicle is in motion) and result in improved reliability of vehicle positioning and navigation and the overall safety of autonomous, semi-autonomous, and other driver assistance systems. As previously noted, in addition to the way in which SAE categorizes levels of automated driving operations, other organizations, in the United States or in other countries, may categorize levels of automated driving operations differently. Without limitation, the disclosed systems and methods herein can be used in driving assistance systems defined by these other organizations' levels of automated driving operations.

The example AV 100 can include a sensing system 110. The sensing system 110 can include various electromagnetic (e.g., optical) and non-electromagnetic (e.g., acoustic) sensing subsystems and/or devices. The sensing system 110 can include a radar 114 (or multiple radars 114), which can be any system that utilizes radio or microwave frequency signals to sense objects within the driving environment 101 of the AV 100. The radar(s) 114 can be configured to sense both the spatial locations of the objects (including their spatial dimensions) and velocities of the objects (e.g., using the Doppler shift technology). Hereinafter, “velocity” refers to both how fast the object is moving (the speed of the object) as well as the direction of the object's motion. The sensing system 110 can include a lidar 112, which can be a laser-based unit capable of determining distances to the objects and velocities of the objects in the driving environment 101. Each of the lidar 112 and radar 114 can include a coherent sensor, such as a frequency-modulated continuous-wave (FMCW) lidar or radar sensor. For example, radar 114 can use heterodyne detection for velocity determination. In some implementations, the functionality of a ToF and coherent radar is combined into a radar unit capable of simultaneously determining both the distance to and the radial velocity of the reflecting object. Such a unit can be configured to operate in an incoherent sensing mode (ToF mode) and/or a coherent sensing mode (e.g., a mode that uses heterodyne detection) or both modes at the same time. In some implementations, multiple lidars 112 or radars 114 can be mounted on AV 100.

Lidar 112 can include one or more light sources producing and emitting signals and one or more detectors of the signals reflected back from the objects. In some implementations, lidar 112 can perform a 360-degree scanning in a horizontal direction. In some implementations, lidar 112 can be capable of spatial scanning along both the horizontal and vertical directions. In some implementations, the field of view can be up to 90 degrees in the vertical direction (e.g., with at least a part of the region above the horizon being scanned with radar signals). In some implementations, the field of view can be a full sphere (consisting of two hemispheres).

The sensing system 110 can further include one or more cameras 118 to capture images of the driving environment 101. The images can be two-dimensional projections of the driving environment 101 (or parts of the driving environment 101) onto a projecting surface (flat or non-flat) of the camera(s). Some of the cameras 118 of the sensing system 110 can be video cameras configured to capture a continuous (or quasi-continuous) stream of images of the driving environment 101. The sensing system 110 can also include one or more infrared (IR) sensors 119. The sensing system 110 can further include one or more sonars 116, which can be ultrasonic sonars, in some implementations.

The sensing data obtained by the sensing system 110 can be processed by a data processing system 120 of AV 100. For example, the data processing system 120 can include a perception and planning system 130. The perception and planning system 130 can be configured to detect and track objects in the driving environment 101 and to recognize the detected objects. For example, the perception and planning system 130 can analyze images captured by the cameras 118 and can be capable of detecting traffic light signals, road signs, roadway layouts (e.g., boundaries of traffic lanes, topologies of intersections, designations of parking places, and so on), presence of obstacles, and the like. The perception and planning system 130 can further receive radar sensing data (Doppler data and ToF data) to determine distances to various objects in the environment 101 and velocities (radial and, in some implementations, transverse, as described below) of such objects. In some implementations, the perception and planning system 130 can use radar data in combination with the data captured by the camera(s) 118, as described in more detail below.

Perception and planning system 130 can include an object detection model 132 component that deploys one or more suitable computer vision models to identify regions in driving environment 101 that include individual objects of interest, e.g., vehicles, pedestrians, animals, and/or the like. Object detection model 132 can crop camera/lidar/radar images into portions (also referred to as patches herein) of images associated with these individual objects.

Perception and planning system 130 can further include a tracking and prediction component 134 to monitor how the driving environment 101 evolves with time, e.g., by keeping track of the locations and velocities of various objects identified by object detection model 132. In some implementations, tracking and prediction component 134 can keep track of the changing appearance of the environment due to a motion of the AV relative to the environment. In some implementations, tracking and prediction component 134 can make predictions about how various tracked objects of the driving environment 101 will be positioned within a prediction time horizon. The predictions can be based on the current locations and velocities of the tracked objects as well as on the earlier locations and velocities (and, in some cases, accelerations) of the tracked objects. For example, based on stored data (referred as “track” herein) for object 1 indicating location/velocity of object 1 during the previous 3-second period tracking and prediction component 134 can conclude that object 1 is maintaining a constant speed. Accordingly, tracking and prediction component 134 can predict where object 1 is likely to be within the next 3 or 5 seconds of motion. As another example, based on track for object 2 indicating decelerated motion of object 2 approaching a road intersection over the previous 2-second period, tracking and prediction component 134 can conclude that object 2 is about to come to a stop sign before making a turn to a side road. Accordingly, tracking and prediction component 134 can predict where object 2 is likely to be within the next 1 or 3 seconds. The tracking and prediction component 134 can perform periodic checks of the accuracy of its predictions and modify the predictions based on new data obtained from the sensing system 110.

Perception and planning system 130 can further include a heading detection model (HDM) 136 that determines heading directions of various objects identified by object detection model 132. “Heading direction” or simply “heading” \vec{h} should be understood as the direction (e.g., a vector) corresponding to a reference axis of an object, e.g., an axis that connects centers of the rear and front axles of a vehicle, rear and front bumpers of the vehicle, the projection of the central plane of the vehicle onto the ground, and/or the like. HDM 136 can receive patches of data corresponding to various objects cropped by object detection model 132. In some implementations, additional input into HDM 136 can include tracks (motion) of these objects generated by tracking and prediction component 134, which can include distance, velocity, acceleration, position of the object relative to the roadway, and/or the like. HDM 136 can use one or more neural networks whose input includes cropped images and tracks of objects and an output determines “heading” \vec{h}, e.g., as an angle in a suitable polar system of coordinates, relative to any reference axis, e.g., an axis fixed relative to Earth (e.g., north-to-south direction), axis defined for a particular driving environment (e.g., an axis associated with an intersection), or a dynamic axis that changes with location (e.g., direction of lane travel on a curved portion of a roadway).

Perception and planning system 130 can further include a loss-of-control (LoC) detection 138 component that uses the heading \vec{h}, determined by HDM 136 for a particular object, to identify that the object is at risk of losing control of its trajectory. Detection of LoC condition can be performed based on additional information that can include a direction of travel \vec{m} (e.g., as can be determined using roadgraph information 124), speed V (e.g., as can be determined using tracking and prediction component 134), type T of an object (e.g., as can be determined by object detection model 132), road conditions C (e.g., dry/wet, paved/unpaved, and/or the like).

Perception and planning system 130 can further receive information from a positioning subsystem 122, which can include a GPS transceiver and/or inertial measurement unit (IMU), configured to obtain information about the position of the AV relative to Earth and its surroundings. The positioning subsystem can use the positioning data, e.g., GPS and IMU data) in conjunction with the sensing data to help accurately determine the location of the AV with respect to fixed objects of the driving environment 101 (e.g., roadways, lane boundaries, intersections, sidewalks, crosswalks, road signs, curbs, surrounding buildings, etc.) whose locations can be provided by roadgraph information 124. In some implementations, the data processing system 120 can receive non-electromagnetic data, such as audio data (e.g., ultrasonic sensor data, or data from a mic picking up emergency vehicle sirens), temperature sensor data, humidity sensor data, pressure sensor data, meteorological data (e.g., wind speed and direction, precipitation data), and the like.

The data generated by the perception and planning system 130, including tracking and prediction component 134, HDM 136, LoC detection 138, and/or the like, and positional subsystem 122, can be used by an autonomous driving system, such as AV control system (AVCS) 140. The AVCS 140 can include one or more algorithms that control how AV is to behave in various driving situations and environments. For example, the AVCS 140 can include a navigation system for determining a global driving route to a destination point. The AVCS 140 can also include a driving path selection system for selecting a particular path through the immediate driving environment, which can include selecting a traffic lane, negotiating a traffic congestion, choosing a place to make a U-turn, selecting a trajectory for a parking maneuver, and so on. The AVCS 140 can also include an obstacle avoidance system for safe avoidance of various obstructions (rocks, stalled vehicles, a jaywalking pedestrian, and so on) within the driving environment of the AV. The obstacle avoidance system can be configured to evaluate the size of the obstacles and the trajectories of the obstacles (if obstacles are animated) and select an optimal driving strategy (e.g., braking, steering, accelerating, etc.) for avoiding the obstacles.

Algorithms and modules of AVCS 140 can generate instructions for various systems and components of the vehicle, such as the powertrain, brakes, and steering 150, vehicle electronics 160, signaling 170, and other systems and components not explicitly shown in FIG. 1. The powertrain, brakes, and steering 150 can include an engine (internal combustion engine, electric engine, and so on), transmission, differentials, axles, wheels, steering mechanism, and other systems. The vehicle electronics 160 can include an on-board computer, engine management, ignition, communication systems, carputers, telematics, in-car entertainment systems, and other systems and components. The signaling 170 can include high and low headlights, stopping lights, turning and backing lights, horns and alarms, inside lighting system, dashboard notification system, passenger notification system, radio and wireless network transmission systems, and so on. Some of the instructions output by the AVCS 140 can be delivered directly to the powertrain, brakes, and steering 150 (or signaling 170) whereas other instructions output by the AVCS 140 are first delivered to the vehicle electronics 160, which generates commands to the powertrain, brakes, and steering 150 and/or signaling 170.

In one example, the AVCS 140 can determine that a vehicle identified by the data processing system 120 as a LoC vehicle (e.g., a vehicle experiencing an oversteering wobble) is to be avoided by decelerating the autonomous vehicle (AV) until a safe speed is reached, which can be followed by steering the AV vehicle away from the LoC vehicle (e.g., away from the lane of travel of the LoC vehicle). The AVCS 140 can output instructions to the powertrain, brakes, and steering 150 (directly or via the vehicle electronics 160) to: (1) reduce, by modifying the throttle settings, a flow of fuel to the engine to decrease the engine rpm; (2) downshift, via an automatic transmission, the drivetrain into a lower gear; (3) engage a brake unit to reduce (while acting in concert with the engine and the transmission) the vehicle's speed until a safe speed is reached; and (4) perform, using a power steering mechanism, a steering maneuver to steer away from the LoC. Subsequently, the AVCS 140 can output instructions to the powertrain, brakes, and steering 150 to resume the previous speed settings of the vehicle.

The “autonomous vehicle” can include motor vehicles (cars, trucks, buses, motorcycles, all-terrain vehicles, recreational vehicle, any specialized farming or construction vehicles, and the like), aircrafts (planes, helicopters, drones, and the like), naval vehicles (ships, boats, yachts, submarines, and the like), robotic vehicles (e.g., factory, warehouse, sidewalk delivery robots, etc.) or any other self-propelled vehicles capable of being operated in a self-driving mode (without a human input or with a reduced human input). “Objects” can include any entity, item, device, body, or article (animate or inanimate) located outside the autonomous vehicle, such as roadways, buildings, trees, bushes, sidewalks, bridges, mountains, other vehicles, piers, banks, landing strips, animals, birds, or other things.

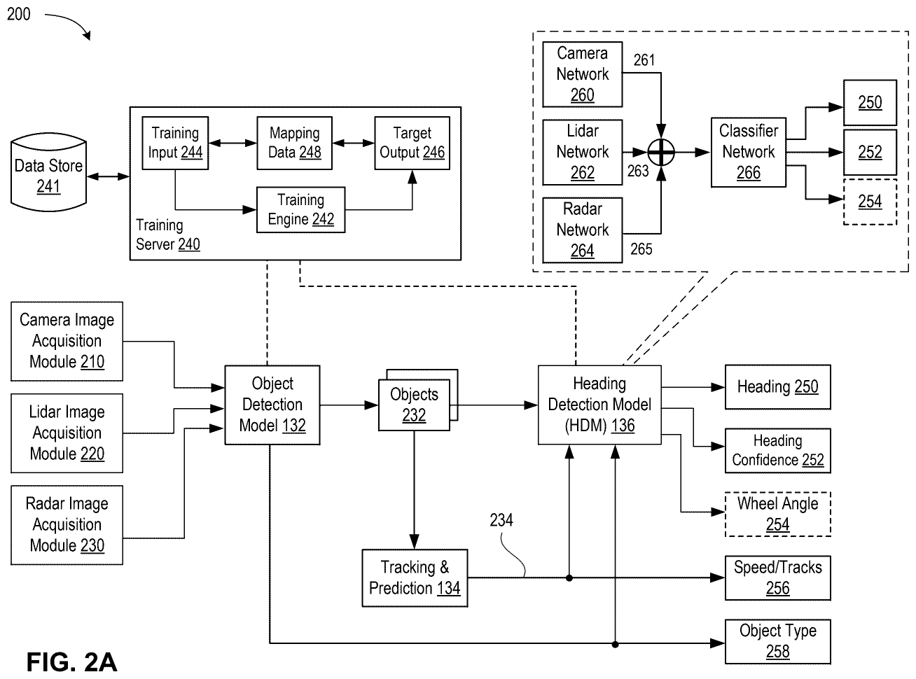

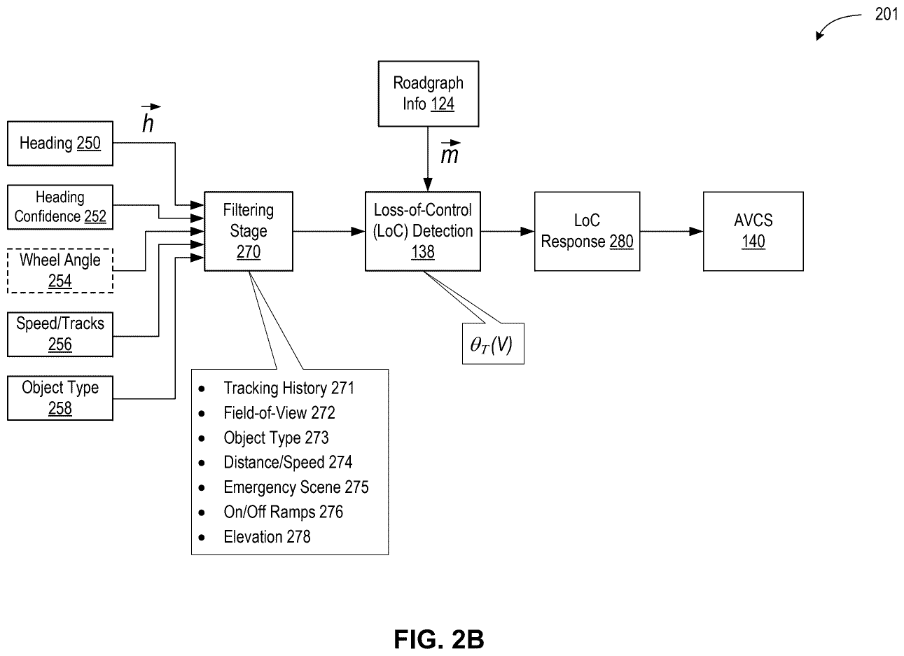

In the description of FIGS. 2-5 below, the term “vehicle” is used to indicate an automotive machine deploying the disclosed techniques that identify objects at risk of LoC. The term “object” is used to indicate an animate road user being observed, tracked, and/or evaluated for the risk of LoC. “Object” can include any type of vehicle, e.g., car, truck, van, SUV, vehicle pulling a trailer, motorcycle, scooter, bicycle, etc., but can also include a pedestrian, an animal, and/or the like.

FIG. 2A is a diagram illustrating a first stage 200 of an example architecture of a part of a vehicle's perception system capable of identifying objects in driving environments that are at risk of LoC, in accordance with some implementations of the present disclosure.

An input into the perception system (e.g., perception and planning system 130 of FIG. 1) can include data obtained by sensing system 110 (e.g., by lidar 112, radar 114, and/or camera(s) 118). The obtained data can be provided to the perception and planning system 130 by a camera image acquisition module 210, a lidar data acquisition module 220, and/or radar data acquisition module 230. More specifically, camera image acquisition module 210 can acquire a sequence of camera images, e.g., two-dimensional projections of the driving environment (or a portion thereof) on an array of sensing detectors (e.g., charged coupled device or CCD detectors, complementary metal-oxide-semiconductor or CMOS detectors, and/or the like). Each camera image can have pixels of various intensities of one color (for black-and-white images) or multiple colors (for color images). The camera images can be panoramic images or images depicting a specific portion of the driving environment. The camera images can include a number of pixels. The number of pixels can depend on the resolution of the image. Each pixel can be characterized by one or more intensity values. A black-and-white pixel can be characterized by one intensity value, e.g., representing the brightness of the pixel, with value 1 corresponding to a white pixel and value 0 corresponding to a black pixel (or vice versa). The intensity value can assume continuous (or discretized) values between 0 and 1 (or between any other chosen limits, e.g., 0 and 255). Similarly, a color pixel can be represented by more than one intensity value, such as three intensity values (e.g., if the RGB color encoding scheme is used) or four intensity values (e.g., if the CMYK color encoding scheme is used). Camera images can be preprocessed, e.g., downscaled (with multiple pixel intensity values combined into a single pixel value), upsampled, filtered, denoised, and the like. Camera image(s) can be in any suitable digital format (JPEG, TIFF, GIG, BMP, CGM, SVG, and so on).

A lidar image acquisition module 220 (and, similarly, radar image acquisition module 230) can provide lidar (radar) images, which can include a set of return points (point cloud) corresponding to laser (radar) beam reflections from various objects in the driving environment. Each return point can be understood as a data unit (pixel) that includes coordinates of reflecting surfaces, radial velocity data, intensity data, and/or the like. For example, lidar image acquisition module 220 (radar image acquisition module 230) can provide the images that includes the intensity map I(R, θ, ϕ), where R, θ, ϕ is a set of spherical coordinates. In some implementations, Cartesian coordinates, elliptic coordinates, parabolic coordinates, or any other suitable coordinates can be used instead. The intensity map identifies an intensity of the lidar (radar) reflections for various points in the field of view. The coordinates of objects (or surfaces of the objects) that reflect lidar (radar) signals can be determined from directional data (e.g., polar θ and azimuthal ϕ angles in the direction of lidar transmissions) and distance data (e.g., radial distance R determined from the time of flight of lidar signals). The lidar and/or radar images can further include velocity data of various reflecting objects identified based on detected Doppler shift of the reflected signals. Although FIG. 2A illustrates an implementation in which three data acquisition modules are deployed, one or more data acquisition modules can be absent (or disabled) in other implementations. For example, the camera image acquisition module 210 and the lidar (or radar) image acquisition module 220 can be deployed while the radar image acquisition module 230 (or lidar image acquisition module 220) is not deployed.

The camera images, lidar images, and/or radar images can be large images of the entire driving environment or images of a significant portion of the driving environment (e.g., camera image acquired by a forward-facing camera(s) of the vehicle's sensing system). The acquired camera, lidar, and/or radar images can be processed by an object detection model 132 that can include a model (or multiple models) trained to identify individual objects 232 in the driving environment and crops camera/lidar/radar images into portions (also referred to as patches herein) of the images associated with the individual objects 232. Object detection model 132 can be (or include) any suitable computer vision model, e.g., a machine learning model trained to identify regions that include objects of interest, e.g., vehicles, pedestrians, animals, etc.

Objects identified by object detection model 132 can be tracked by tracking and prediction component 134, which maintains and updates various geo-motion data related to the motion of the objects between different timestamp tⱼ, e.g., \vec{R}(tⱼ), velocity \vec{V}(tⱼ), acceleration \vec{a}(tⱼ), angular velocity \vec{ω}(tⱼ), etc. In some implementations, tracking and prediction component 134 can deploy a suitable statistical filter, e.g., Kalman filter. Kalman filter computes: (i) a most probable geo-motion data in view of the measurements (images) obtained, (ii) predictions made according to a physical model of object's motion, and (ii) statistical assumptions about measurement errors (e.g., covariance matrix of errors). Based on this collected data, tracking and prediction component 134 can estimate, for a certain time horizon (e.g., one or several second), an accurate future motion of the object.

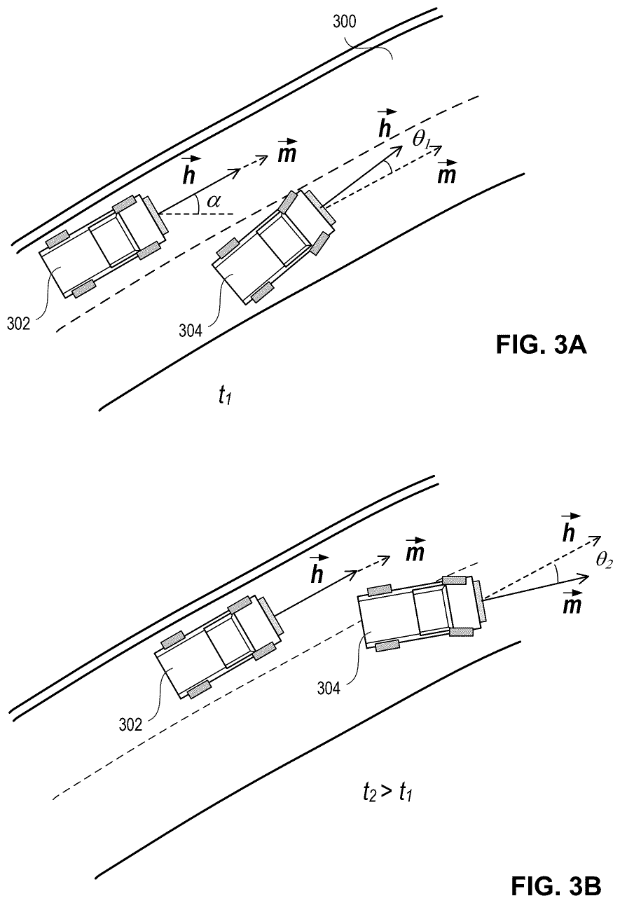

Camera, lidar, and/or radar image patches cropped using object detection model 132 can be provided to HDM 136 that uses the provided patches to determine heading 250 of a respective object 232, which can be have any suitable representation, e.g., in terms of Cartesian coordinates \vec{h}=(hₓ, h_{y}) of the heading vector \vec{h}, or in terms of a polar angle α that heading 250 makes with a certain reference direction (e.g., as illustrated with FIG. 3A for object 302). In some implementations, the components hₓ, h_{y} and/or angle α may be continuous values. In some implementations, the components hₓ, h_{y} and/or angle α may assume one or discrete sets of values (bins). In some implementations, HDM 136 can further output heading confidence 252 indicative of the level of confidence in the determined heading 250. In some implementations, HDM 136 can further output a wheel angle 254 that the front wheels of the object 232 (e.g., vehicle) make with the heading 250, e.g., with positive/negative values of the wheel angle indicative of the front wheels turned left/right (or vice versa). In some implementations, HDM 136 can have additional inputs, e.g., tracks of objects 232 (provided by tracking and prediction components 134), object types 258 (determined by object detection model 132), and/or other suitable inputs.

In some implementations, HDM 136 can use decision-tree algorithms, support vector machines, deep neural networks, and the like. Deep neural networks can include convolutional neural networks, recurrent neural networks (RNN) with one or more hidden layers, fully connected neural networks, long short-term memory neural networks, transformers, Boltzmann machines, and so on.

Object detection model 132 and/or HDM 136 can be trained using actual camera images, lidar images, and/or radar images depicting objects present in various driving environments, e.g., urban driving environments, highway driving environments, rural driving environments, off-road driving environments, and/or the like. Training can be performed by a training engine 242 hosted by a training server 240, which can be an outside server that deploys one or more processing devices, e.g., central processing units (CPUs), graphics processing units (GPUs), and/or the like. In some implementations, object detection model 132 and/or HDM 136 can be trained by training engine 242 and subsequently downloaded onto the perception system of the AV. Object detection model 132 and/or HDM 136, as illustrated in FIG. 2A, can be trained using training data that includes training inputs 244 and corresponding target outputs 246 (correct matches for the respective training inputs 244). During training of object detection model 132 and/or HDM 136, training engine 242 can find patterns in the training data that maps training inputs 244 to the target outputs 246.

Training engine 242 can have access to a data store 241 storing multiple camera images, lidar images, and/or radar images for actual driving situations in a variety of environments. Training inputs 244 can be annotated with labels or some other suitable mapping data 248 (ground truth annotations), that map training inputs 244 to the corresponding target outputs 246, e.g., including but not limited to correct identification of the heading of the vehicle, a turning angle of the vehicle's wheels, and/or other similar information. In some implementations, annotations can be made using human inputs. Stored training inputs 244 can include large datasets (e.g., with hundreds or thousands of images or more) that include cropped camera image/lidar/radar patches. In some implementations, ground truth annotations can be made by a developer before the annotated training inputs are stored in the data store 241. During training, training server 240 can retrieve annotated training data from the data store 241, including one or more training inputs 244 and one or more target outputs 246 mapped by mapping data 248.

During training of object detection model 132 and/or HDM 136, training engine 242 can change parameters (e.g., weights and biases) of object detection model 132 and/or HDM 136 until the models successfully learn how to predict correct target outputs 246. In some implementations, object detection model 132 and/or HDM 136 can be trained separately. In various implementations, more than one HDM 136 can be trained to be used under different conditions and for different driving environments, e.g., separate HDMs 136 can be trained for highway driving environments and unpaved driving environments. Different HDMs 136 can have different architectures (e.g., different numbers of neuron layers and different topologies of neural connections), different settings (e.g., activation functions, etc.), and can be trained using different sets of hyperparameters.

Data store 241 can be a persistent storage capable of storing lidar data, camera images, as well as data structures configured to facilitate accurate and fast identification and validation of sign detections, in accordance with various implementations of the present disclosure. Data store 241 can be hosted by one or more storage devices, such as main memory, magnetic or optical storage disks, tapes, or hard drives, network-attached storage (NAS), storage area network (SAN), and so forth. Although depicted as separate from training server 240, in some implementations, data store 241 can be a part of training server 240. In some implementations, data store 241 can be a network-attached file server, while in other implementations, data store 241 can be some other type of persistent storage such as an object-oriented database, a relational database, and so forth, that can be hosted by a server machine or one or more different machines accessible to the training server 240 via a network (not shown in FIG. 2A).

In some implementations, HDM 136 can have architecture illustrated with the callout portion of FIG. 2A, which includes a camera network 260, a lidar network 262, and/or a radar network 264 trained to process input data of the corresponding modalities. For example, camera network 260 can process a camera patch associated with an individual object 232 and generate a camera embedding 261 (also referred to as a feature vector) that constitutes a digital representation of various appearance features of the object of interest in the patch. During training of HDM 136, camera network 260 learns how to encode appearance features via efficient camera embedding(s) 261. Camera embedding 261 can have 256 bits, 512 bits, 1024 bits, or some other number of bits that can be set empirically, e.g., together with architecture of camera network 260, based on experimentation to determine the optimal value of bits for a given target environment. In some implementations, camera network 260 can be (or include) a neural network of artificial neurons. The neurons can be associated with learnable weights and biases. The neurons can be arranged in layers. Some of the layers can be hidden layers. Camera network 260 can include multiple hidden neuron layers and can be configured to perform computations that enable detection of heading, wheel angle, and/or the like. In some implementations, camera network 260 can include a number of convolutional layers with any suitable parameters, including kernel/mask size, kernel/mask weights, sliding step size, and the like. Convolutional layers can alternate with padding layers and can be followed with one or more pooling layers, e.g., maximum pooling layers, average pooling layers, and the like. Some of the layers of camera network 260 can be fully connected layers. In some implementations, camera network 260 can be a network of fully connected layers, a convolutional neural network, a recurrent neural network (RNN), a long short-term model (LSTM), a network with attention, a transformer network, and/or the like, or some combination thereof.

Similarly, a lidar (radar) patch can be processed by lidar network 262 (radar network 264) to generate a lidar embedding 263 (radar network 264) that constitutes a digital representation of a portion of the lidar (radar) point cloud captured by the lidar (radar) patch. Training of HDM 136 causes lidar network 262 (and/or radar network 264) to generate lidar embeddings 263 (radar embeddings 265) that efficiently represent visual features of the captured object. Lidar embeddings 263 (radar embeddings 265) can have the same number of bits as camera embedding 261. In some implementations, the number of bits of lidar embeddings 263 (radar embeddings 265) can be different from the number of bits of camera embeddings 261. In some implementations, lidar network 262 (and/or radar network 264) can have a U-net architecture, in which a convolutional subnetwork (encoder) downsizes features of the lidar patch (and/or radar patch) along its height and width dimensions and increases the size along the feature dimension. A deconvolutional network (decoder) then expands the features along the width and height dimensions while simultaneously reducing the feature dimension. In some implementations, lidar embeddings 263 (radar embeddings 265) can encode information about segmentation of the lidar (radar) patches, e.g., information about various pixels of the patches belonging to separate clusters associated with different parts of the object of interest, e.g., body of a car, car door, hood, tailgate, wheels, vehicle attachments, and/or the like.

In some implementations, various additional network architectures or variations of network architectures can be used to implement camera network 260, lidar network 262, and/or radar network 264, such as networks with residual connections, networks with multiple paths, networks with attention (self-attention and cross-attention), transformer networks, convolutional neural networks with sparse convolutions, and/or the like.

Camera embedding 261 can be combined with lidar embedding 263 and can further be combined with radar embedding 265 (e.g., concatenated or otherwise aggregated) and the combined embedding can be processed by a classifier network 266. In some implementations, classifier network 266 can include a backbone (which can include one or more fully connected layers) and one or more classification heads that are trained to output respective classifications, e.g., heading 250, heading confidence 252, wheel angle 254, and/or the like.

In some implementations, processing by HDM 136 can be performed individually for each frame of training sensing data, e.g., camera/lidar/radar data collected for a given timestamp tp. In some implementations, HDM 136 can simultaneously process a sliding window of frames t₁, t₂, . . . t_{N} of input data, with the window sliding by a certain number M≤N of frames at each processing iteration. In some implementations, the input data processed by HDM 136 can also include data received from infrared (IR) sensors 119 (with reference to FIG. 1).

The outputs of HDM 136 can be processed (e.g., as disclosed in conjunction with FIG. 2B) by LoC detection 138. In some implementations, LoC detection 138 can further use outputs of tracking and prediction component 134, e.g., speed 256 of objects 232, object type 258 determined by object detection model 132, and/or the like.

In some implementations, the output of training and prediction component 134 can include tracks 234 for various objects 232. Tracks 234 can specify transitions between states of motion of objects 232. For example, a given track 234 can characterize a state S(tⱼ) of the object at time tⱼ, e.g., S(tⱼ)={X(tⱼ), V(tⱼ), a(tⱼ)}, including the coordinates X(tⱼ) of the object, velocity V(tⱼ) of the object, acceleration of the object a(tⱼ), and/or the like. As the additional outputs of object detection model 132 are generated for subsequent times tⱼ₊₁, tⱼ₊₂, . . . , training and prediction component 134 can update the state of the object, e.g., as S(tⱼ)→S(tⱼ₊₁)={X(tⱼ)+V(tⱼ)(tⱼ₊₁−tⱼ)+a(tⱼ)(tⱼ₊₁−tⱼ)²/2, V(tⱼ)+a(tⱼ)(tⱼ₊₁−tⱼ), a(tⱼ₊₁)}, in one example non-limiting implementation. In some implementations, the state of the object can be updated using a Kalman filter that computes a weighted combination of a predicted state of the motion (based on a physics model of the object's motion) and an observed state of the motion (generated by object detection model 132).

FIG. 2B is a diagram illustrating a second stage 201 of the example architecture of the part of the vehicle's perception system capable of identifying objects in driving environments that are at risk of LoC, in accordance with some implementations of the present disclosure. The second stage 201 can include an LoC detection 138 module. In some implementations, LoC detection 138 can deploy one or more heuristics, formulas, tables, and/or the like. In some implementations, LoC detection 138 can include one or more decision tree algorithms and/or other machine learning techniques, including but not limited to support vector machines.

In various implementations, LoC detection 138 can use, as inputs, one or more of the data associated with blocks 250-258, such as (but not limited to) heading 250 of a given object, heading confidence 252 (indicative of how accurately the heading 250 has been determined, e.g., by HDM 136), wheel angle 254, speed/tracks 256 of the object, type of the object, and/or the like. LoC detection 138 can further use roadgraph information 124, such as roadway boundaries, lane boundaries, topology of roadway intersections, locations of road signs, streetlights, pedestrian crossings, and/or any other road layout information. In some implementations, roadgraph information 124 can be integrated with geo-motion data provided by tracking and prediction component 134 and can include locations of objects relative to various road features, e.g., an edge of the road, lane markings, distance to an intersection, and/or the like.

In some implementations, prior to processing the input data by LoC detection 138, the perception system of a vehicle can deploy one or more filters of a filtering stage 270 to determine whether LoC detection processing is appropriate or is likely to lead to false positive detections. For example, filtering stage 270 can include a tracking history filter 271 that determines a duration T of tracking the object. If duration T is less than a set threshold time To (e.g., one to several seconds, depending on a driving environment), the object can be an artifact rather than a real object, e.g., a reflection of another object by a mirror-like surface (such as a window or side panel of another vehicle). Once the object has been observed for at least time T₀, the filtering stage 270 can accept the object as the real object and pass the information about the object to LoC detection 138.

Filtering stage 270 can further include a field-of-view filter 272 that determines whether the sensing system of the vehicle has a clear view of the object. For example, if the view of the object is acquired through a window of another object (car, bus, and/or the like), field-of-view filter 272 can determine that the heading 250 and/or speed/tracks 256 of the object are not reliable enough to initiate LoC detection processing. Similarly, if a portion (e.g., at least a certain threshold portion of the object's body, such as 30%, 40%, 50%, etc.) of the object is obscured by other (more closely positioned) objects, field-of-view filter 272 can determine that the reliability of the sensing data is not sufficient and can prevent or postpone LoC detection processing.

Filtering stage 270 can further include an object type filter 273 that determines whether the object is of a type for which the LoC detection 138 is suitable. For example, if object type 258 is a vehicle, object type filter 273 can initiate LoC detection 138. If object type 258 is not a vehicle, e.g., a cloud of dust blown across the highway or an animal (e.g., deer) crossing the roadway, LoC detection 138 is not used (while the object's presence being handled by AVCS 140 using other appropriate algorithms and heuristics). In some implementations, if the object is a police vehicle, the object type filter 273 does not initiate LoC detection 138 processing (e.g., under the presumption that a police vehicle is not expected to be driven in a way that places the police vehicle at risk of a loss of control).

Filtering stage 270 can further include a distance/speed filter 274 that determines whether the object is too far from the vehicle to be of concern. For example, if the object is at such distance d and the flow of traffic (including the vehicle) is moving with speed u, distance/speed filter 274 can determine that at least time d/u will pass before the vehicle reaches the object even if the object is to decelerate dramatically, e.g., as a result of spinning, hitting another object, and/or the like. If time d/u is above (or above with a certain safety cushion) the time sufficient to stop or decelerated the vehicle to a low and safe speech, distance/speed filter 274 can disable LoC detection 138 processing for the object at the present time, but can enable such processing at a later time, e.g., if distance d and/or speed of traffic (and/or the vehicle's speed) changes.

Filtering stage 270 can further include an emergency scene filter 275 that determines whether a scene of a road emergency (e.g., incident, road closure) and/or medical emergency has developed. For example, if one or more emergency vehicles are present at or near the scene of object detection, emergency scene filter 275 can presume that the traffic pattern is significantly modified from normal driving conditions so that LoC detection 138 is not to be initiated.

Filtering stage 270 can further include an on/off ramps filter 276 that determines whether the object is traveling on (or, in some implementations, towards or away from) an on-ramp (highway entry ramp) or an off-ramp (highway exit ramp). In such instances, the on/off ramps filter 276 can also disable application of LoC detection 138. Additional filtering can be performed based on heading confidence 252, which can be outputted by HDM 136. In those instances where heading confidence 252 is less than a predetermined threshold, e.g., 50%, 60%, and/or the like, filtering stage 270 can also disable application of LoC detection 138. Filtering stage 270 can also include an elevation filter 278 that determines an elevation (height) of the object above the roadway and disables application of LoC detection 138 in the instances of the elevation being above a certain threshold (e.g., several meters), to eliminate false positives associated with vehicles that travel on overpasses, bridges, and/or the like.

In some implementations, operations of the enabled LoC detection 138 can be performed as illustrated below. FIGS. 3A-3B depict schematically a pattern of normal motion of an object and a pattern of motion that places an object at risk of a loss of control, in accordance with some implementations of the present disclosure. FIG. 3A illustrates an object 302 (e.g., a safely driven car) traveling in the left lane of a two-lane highway 300 and positioned at some location at time t₁. As shown, the heading \vec{h} of object 302 is substantially the same as (or insignificantly different) from its direction of travel \vec{m}. The direction of travel \vec{m} can be determined from roadgraph information 124 that includes a map of lanes for a particular driving area occupied by object 302. For example, the direction of travel \vec{m} can be identified as the direction of the tangent line to the lane boundaries at the location of object 302 (and, similarly, for various other detected objects, e.g., object 304). In some implementations, static roadgraph information 124 can be outdated, e.g., as a result of a new and/or unmapped road closure, construction zone, and/or the like. In such instances, dynamic data obtained by the sensing system (e.g., using computer vision models processing camera and/or lidar images) and indicating lane boundaries (e.g., shifting lanes in a construction zone) can be prioritized over the static roadgraph information 124.

For some objects, e.g., object 304 in FIG. 3A, the heading h and the direction of travel \vec{m} can differ by some yaw angle, e.g., θ₁>0, as shown. As illustrated in FIG. 3B, as the object(s) move, the relative orientation of the heading \vec{h} and the direction of travel \vec{m} can change. For example, object 304 that initiated an aggressive lane change (e.g., from the right lane to the left lane) and, as a result, losing traction of the rear wheels with the roadway can overcorrect by steering to the right causing object 304 to skid in the opposite direction, θ₂<0.

Referring again to FIG. 2B, LoC detection 138 can evaluate the yaw angle θ, e.g., identified for one or more frames of sensing data. In some implementations, yaw angle θ can be compared to a stored dependence of a threshold yaw angle θ_{T}(V) on a speed V of the object. For yaw angles θ that are less than the threshold yaw angle, θ<θ_{T}(V), LoC detection 138 can determine that the object is not likely to lose control of its driving trajectory. For yaw angles that exceed the threshold yaw angle, θ>θ_{T}(V), LoC detection 138 can determine that the object is at risk of LoC.

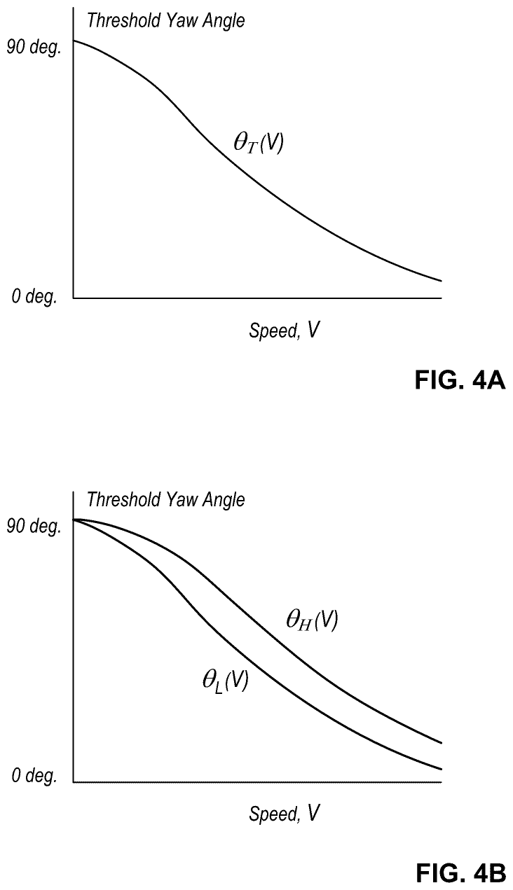

FIGS. 4A-4B illustrate schematically a threshold yaw angle dependence on a speed of an object that can be used for detection of loss of control in driving environments, in accordance with some implementations of the present disclosure. As illustrated in FIG. 4A, in some implementations, at low speeds, threshold yaw angle θ_{T}(V) can be unlimited, e.g., as indicated with the threshold yaw angle reaching 90 degrees corresponding to a situation where an object is capable of moving across the roadway without LoC risk. (In some driving environments, the yaw angle can exceed 90 degrees, e.g., for cars making a U-turn across a city street.) As the speed V increases, the threshold yaw angle θ_{T}(V) decreases. At highway speeds, e.g., 60-70 mph, the threshold yaw angle can be small, e.g., of order of several degrees.

In some implementations, a threshold yaw angle dependence on speed V can be determined using expert driver testing runs. For example, an expert driver can drive a vehicle of a particular kind, e.g., a passenger car, an SUV, a truck, a motorcycle, etc., and perform lane changes (or other lateral driving maneuvers) at yaw angles that are perceived by the expert driver to be at or close to the traction limits for that particular vehicle for various speeds V. A suitable testing equipment, including but not limited to a lidar/radar speed sensing unit, accelerometer, IMU, and/or the like, can record the speed and yaw angle of the test vehicle and subsequently use the recorded data to generate a dataset that includes the threshold yaw angle θ_{T}(V) as a function of speed (or multiple such functions).

In some implementations, instead of (or in addition to) the driver-controlled test runs, determination of the threshold yaw angle θ_{T}(V) can be performed using laboratory traction testing of tires or tire materials and identifying an amount of traction that the tires make with a pavement material (e.g., asphalt, concrete, etc.) at various lateral forces applied to the tires. The forces can then be related to the yaw angles using various models (e.g., physics-based models) that compute such lateral forces for vehicles of specific types caused by various lateral accelerations of the vehicles associated with lane changes, cornering maneuvers, and/or the like. This modeling can subsequently be used to determine the threshold yaw angle θ_{T}(V) dependence on speed of the vehicle.

In some implementations, determining the dependence of the threshold yaw angle θ_{T}(V) on the speed V can be performed using pure simulations, without expert test drives or laboratory testing.

In some implementations, test drives, laboratory testing, and/or simulations, or any combination thereof, can determine the existence of multiple features in the threshold yaw angle dependence on speed. For example, as illustrated in FIG. 4B, a high threshold yaw angle θ_{H}(V) and a low threshold yaw angle θ_{L}(V) can be defined. The high threshold yaw angle can be used as the boundary above which, for angles θ>θ_{H}(V), the loss of control is most likely to occur. The low threshold yaw angle can be used as the boundary below which, for angles θ<θ_{L}(V), the loss of control is unlikely to occur. In the intermediate range of the yaw angles, θ_{L}(V)≤θ≤θ_{H}(V), the loss of control may or may not occur, depending on various other factors that can be difficult to ascertain, including but not limited to tire type, tire quality, tire wear, tire pressure, suspension settings (e.g., stiffness, travel, etc.), driver's skills, and/or the like.

Referring again to FIG. 2B, having identified that the yaw angle is above the high threshold θ>θ_{H}(V), LoC detection 138 can determine that LoC by a particular object is highly likely and can implement an active LoC response 280. For example, LoC detection 138 can presume that the object is to lose traction immediately and output, to AVCS 140, instructions to execute a driving maneuver that maximizes the separation between the vehicle and the object, e.g., by braking, nudging, moving to a different lane, and/or the like.

In those instances, where LoC detection 138 identifies that the yaw angle is below the low threshold θ<θ_{L}(V), no LoC response 280 can be initiated as the object is unlikely to lose control of its trajectory.

In those instances, where LoC detection 138 identifies that the yaw angle is within the intermediate range, θ_{L}(V)<θ<θ_{H}(V), LoC detection 138 can initiate a moderate LoC response 280, e.g., slowing down without using hard braking and/or without changing lanes while tracking subsequent motion of the object.

In some implementations, selection of LoC response 280 can be informed by heading confidence 252. For example, in those instances where heading confidence 252 is above an empirically determined high confidence threshold (e.g., 70%, 80%, etc.), the selection of LoC response 280 can be performed as described above. In those instances where heading confidence 252 is below the high confidence threshold but above another empirically set low confidence threshold (e.g., 40%, 50%, etc.), LoC response 280 can be reduced by one level. For example, in the instances of high yaw angles, θ>θ_{H}(V), the moderate LoC response 280 can be selected, and in the instances of intermediate or low yaw angles, θ<θ_{H}(V), no LoC response 280 can be initiated yet. Instead, the perception system can perform further observation and tracking of the object until the heading confidence 252 improves, the yaw angle escalates into the range of high yaw angles or de-escalates into the range of low (or normal) yaw angles.

Although in the above example, LoC response 280 is determined using two threshold yaw angles, θ_{L}(V) and θ_{H}(V), in other implementations, a single threshold yaw angle θ(V) can be used (e.g., as illustrated in FIG. 3A) with two ranges of yaw angles defined, e.g., low yaw angles θ≤θ(V) and high yaw angles θ>θ(V). In some implementations, more than two thresholds can be defined with gradually escalating levels of LoC response 280.

In some implementations, an object identified, for one or more sensing frames, to be at risk of LoC can be obscured from direct view of the sensing system of the vehicle over a number of subsequent sensing frames. In such instances, LoC detection 138 can maintain (“latch to”) the track of the object for a certain (e.g., empirically set) time. If a clear field of view of the object is re-acquired within this time, tracking of the object can continue.

In some implementations, a separate set of one or more threshold yaw angles, {θ_{T}(V; T, C)}=θ₁(V; T, C), θ₂(V; T, C), . . . , θ_{M}(V; T, C), can be defined (and measured/simulated/etc.) for different types T of objects, e.g., passenger car, sport-utility vehicle, bus, truck, motorcycle, and/or the like. In some implementations, separate sets of threshold yaw angles can be defined for different road conditions C, e.g., dry pavement, wet pavement, unpaved road, and/or the like. The road condition C can be determined, based on lidar data and/or camera images, e.g., using a suitable computer vision model.

LoC response 280 can be implemented by AVCS 140, including but not limited to performing immediate braking, delayed braking, nudging within the same lane of travel, moving to a different lane, and/or otherwise increasing a separation between the vehicle and the object. In some implementations, LoC response 280 can be postponed. For example, if the perception system of the vehicle can determine that the distance between the vehicle and the object is such that immediate braking with deceleration a₁ (e.g., 0.2 g) is sufficient to avoid the object in the worst-case scenario that the object is to lose control of its driving trajectory immediately. The perception system can further determine that if implementation of LoC response is delayed by some time τ (e.g., 1 second) and that avoiding the object would then entail braking with deceleration a₂ (e.g., 0.5 g), the perception system can evaluate whether the deceleration a₂ can be performed safely (e.g., without putting the vehicle itself at a risk of LoC). If it is determined that braking later and harder is still safe for the vehicle, the perception system can select this delayed braking in order to have more time to observe the object to evaluate whether the risk of LoC for the object increases or decreases with time.

In one example, the perception system of a vehicle capable of the maximum deceleration a_{MAX}=0.6 g=5.9 m/s² and moving with speed u=65 mph=29 m/s determines that an object, e.g., a car, is at risk of LoC and located ahead of the vehicle at distance d=u²/2a_{MAX}=71 m (just sufficient to bring the vehicle to a complete stop before reaching the object) or less than this distance, LoC response 280 can include causing AVCS 140 to perform immediate braking. On the other hand, if the object is at distance D=100 m in front of the vehicle, LoC response 280 can be delayed by one second (since D−d=29 m is the distance covered by the vehicle in that one second) to observe and track the object before initiating braking. If during this observation period, the yaw angle of the object moves away from the threshold towards the normal range of yaw angles, braking can be further delayed. If, on the other hand, after the observation period, the yaw angle remains above the threshold (or increases), AVCS 140 can engage brakes of the powertrain, brakes, and steering 150 (with reference to FIG. 1) to slow down the vehicle with deceleration a_{MAX},

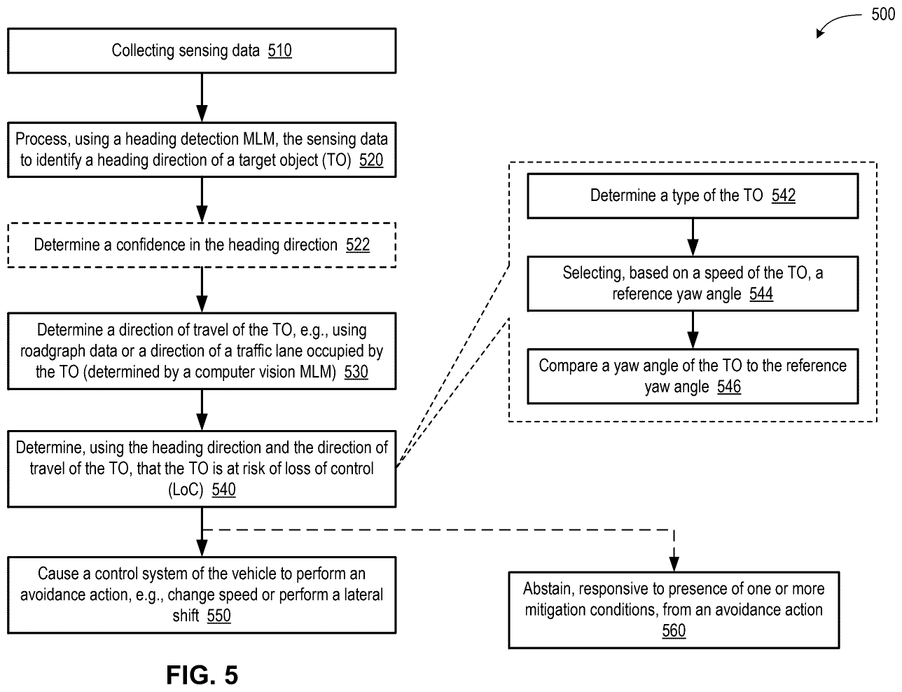

FIG. 5 illustrates an example method 500 of identifying and responding to presence of objects in driving environments that are at risk of loss of control of their driving trajectories, in accordance with some implementations of the present disclosure. A processing device, having one or more processing units (CPUs), one or more graphics processing units (GPUs), one or more parallel processing units (PPUs) and memory devices communicatively coupled to the CPU(s), GPU(s), and/or PPU(s) can perform method 500 and/or each of its individual functions, routines, subroutines, or operations. Method 500 can be directed to systems and components of a vehicle. In some implementations, the vehicle can be an autonomous vehicle. In some implementations, the vehicle can be a driver-operated vehicle equipped with driver-assistance systems, e.g., Level 2 or Level 3 driver assistance systems, that provide limited assistance with specific vehicle systems (e.g., steering, braking, acceleration, etc. systems) or under limited driving conditions (e.g., highway driving). The processing device executing method 500 can perform instructions issued by the perception and planning system 130 of FIG. 1. In certain implementations, a single processing thread can perform method 500. Alternatively, two or more processing threads can perform method 500, each thread executing one or more individual functions, routines, subroutines, or operations of the method. In an illustrative example, the processing threads implementing method 500 can be synchronized (e.g., using semaphores, critical sections, and/or other thread synchronization mechanisms). Alternatively, the processing threads implementing method 500 can be executed asynchronously with respect to each other. Some operations of method 500 can be performed in a different order compared with the order shown in FIG. 5. Some operations of method 500 can be performed concurrently with other operations. Some operations can be optional.

At block 510, method 500 can include collecting sensing data using a sensing system of an autonomous vehicle (e.g., sensing system 110). The sensing data can include one or more camera images of a target object (TO), one or more lidar images of the TO, or one or more radar images of the TO, or any combination thereof.

At block 520, method 500 can continue with processing the sensing data using a heading detection machine learning model MLM (e.g., HDM 136 in FIG. 2A). The heading detection MLM can identify a heading direction of the TO (e.g., heading h in FIGS. 2A-2B). In some implementations, as indicated with block 522, processing the sensing data using the heading detection MLM can further determine a confidence in the identified heading direction.

In some implementations, the heading detection MLM can be trained to use data of one or more sensing modalities. For example, the heading detection MLM can include (e.g., as illustrated in the inset of FIG. 2A) a camera neural network configured to process the one or more camera images of the TO and generate a camera feature vector (FV, e.g., camera embedding 261). The heading detection MLM can also include a lidar neural network configured to process the one or more lidar images of the TO and generate a lidar FV (e.g., lidar embedding 263). The heading detection MLM can further include a lidar neural network configured to process the one or more radar images of the TO and generate a radar FV (e.g., radar embedding 265). The heading detection MLM can further include a classification neural network configured to process the camera FT, the lidar FT, and the radar FT and to output the heading direction of the TO.

In some implementations, the heading detection MLM can be trained using dropout techniques. More specifically, the heading detection MLM can be trained using one or more first training inputs associated with each of a plurality of sensing modalities that include two or more of (i) a camera modality, (ii) a lidar modality, or (iii) and a radar modality. The heading detection MLM can be further trained using one or more second training inputs associated with one or more sensing modalities that lack at least one sensing modality of the plurality of sensing modalities, e.g., with camera and lidar modalities, with camera and radar modalities, with only camera modality, with only lidar modality, and/or the like.

At block 530, method 500 can include determining the direction of travel of the TO. In some implementations, the direction of travel (e.g., nm in FIGS. 2A-2B) can be determined using a (static) roadgraph data for a portion of a roadway associated with a current location of the TO, or a (dynamic) direction of a traffic lane occupied by the TO, which can be determined by a computer vision MLM.

At block 540, method 500 can include determining, using the heading direction and the direction of travel of the TO, that the TO is at risk of a loss of control (LoC) of a driving trajectory of the TO. In some implementations, determining that the TO is at risk of LoC can include operations of the callout portion of FIG. 5. More specifically, at block 542, method 500 can determine, based on the collected sensing data and using an object detection MLM, a type of the TO. At block 544, method 500 can include selecting, based on a speed of the TO, a reference yaw angle for the TO. In some implementations, selecting the reference yaw angle can be further based on the type of the TO determined at block 542. In some implementations, selecting the reference yaw angle can be further based on road conditions, e.g., wet/dry road surface, paved/unpaved road, and/or the like. At block 546, method 500 can include comparing, to the reference yaw angle, a yaw angle that the heading direction makes with the direction of travel.

At block 550, method 500 can continue with selecting an avoidance action and causing a driving control system of the autonomous vehicle (e.g., AVCS 140) to perform the selected avoidance action. The avoidance action can include a change of a speed of the autonomous vehicle, e.g., braking or acceleration. The avoidance action can also include a lateral shift of the autonomous vehicle, e.g., a nudge within the same traffic lane, a change of the traffic lane, and/or the like. In some implementations, causing the control system of the autonomous vehicle to perform the avoidance action is responsive to the confidence (e.g., determined at block 522) being above a threshold value.

In some implementations, as indicated with block 560, method 500 can include abstaining, responsive to presence of one or more mitigating conditions, from a second avoidance action. The one or more mitigating conditions (whose presence can be established by filtering stage 270 in FIG. 2B) can include the confidence in the heading direction being below a threshold value, a field of view of the second TO being at least partially obstructed, a distance to the TO being above a threshold distance, the TO being of an exempt object type, presence of one or more emergency vehicles, the TO exiting a highway, entering the highway, and/or the like, or some combination thereof.

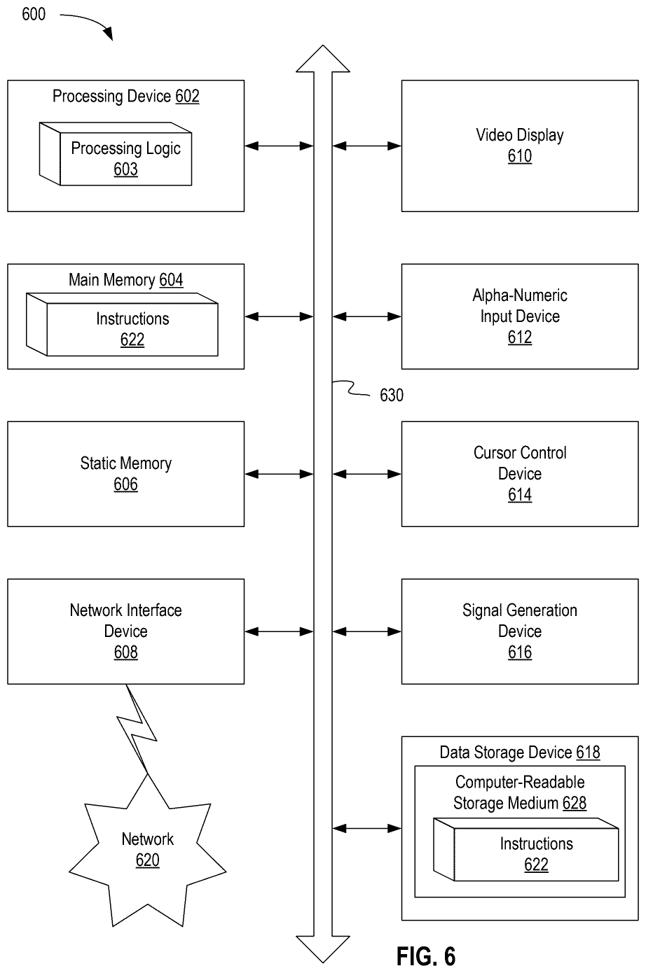

FIG. 6 depicts a block diagram of an example computer device 600 capable of identifying and responding to presence of objects in driving environments that are at risk of loss of control of their driving trajectories, in accordance with some implementations of the present disclosure. Example computer device 600 can be connected to other computer devices in a LAN, an intranet, an extranet, and/or the Internet. Computer device 600 can operate in the capacity of a server in a client-server network environment. Computer device 600 can be a personal computer (PC), a set-top box (STB), a server, a network router, switch or bridge, or any device capable of executing a set of instructions (sequential or otherwise) that specify actions to be taken by that device. Further, while only a single example computer device is illustrated, the term “computer” shall also be taken to include any collection of computers that individually or jointly execute a set (or multiple sets) of instructions to perform any one or more of the methods discussed herein.

Example computer device 600 can include a processing device 602 (also referred to as a processor or CPU), a main memory 604 (e.g., read-only memory (ROM), flash memory, dynamic random access memory (DRAM) such as synchronous DRAM (SDRAM), etc.), a static memory 606 (e.g., flash memory, static random access memory (SRAM), etc.), and a secondary memory (e.g., a data storage device 618), which can communicate with each other via a bus 630.

Processing device 602 (which can include processing logic 603) represents one or more general-purpose processing devices such as a microprocessor, central processing unit, or the like. More particularly, processing device 602 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. In accordance with one or more aspects of the present disclosure, processing device 602 can be configured to execute instructions performing method 500 of identifying and responding to presence of objects in driving environments that are at risk of loss of control of their driving trajectories.

Example computer device 600 can further include a network interface device 608, which can be communicatively coupled to a network 620. Example computer device 600 can further comprise a video display 610 (e.g., a liquid crystal display (LCD), a touch screen, or a cathode ray tube (CRT)), an alphanumeric input device 612 (e.g., a keyboard), a cursor control device 614 (e.g., a mouse), and an acoustic signal generation device 616 (e.g., a speaker).

Data storage device 618 can include a computer-readable storage medium (or, more specifically, a non-transitory computer-readable storage medium) 628 on which is stored one or more sets of executable instructions 622. In accordance with one or more aspects of the present disclosure, executable instructions 622 can comprise executable instructions performing method 500 of identifying and responding to presence of objects in driving environments that are at risk of loss of control of their driving trajectories.

Executable instructions 622 can also reside, completely or at least partially, within main memory 604 and/or within processing device 602 during execution thereof by example computer device 600, main memory 604 and processing device 602 also constituting computer-readable storage media. Executable instructions 622 can further be transmitted or received over a network via network interface device 608.

While the computer-readable storage medium 628 is shown in FIG. 6 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A system comprising:
a sensing system of an autonomous vehicle, the sensing system configured to collect sensing data for an environment of the autonomous vehicle; and
a perception system of the autonomous vehicle, the perception system configured to:
identify a heading direction of an object in the environment, based at least on the sensing data;
determine that the object is at risk of loss of control of a driving trajectory, based at least on a difference between the heading direction and a direction of travel of the object; and
cause a control system of the autonomous vehicle to perform an avoidance action.

2. The system of claim 1, wherein to determine that the object is at risk of loss of control, the perception system is configured to:
select, based on a speed of the object, a reference yaw angle for the object; and
compare, to the reference yaw angle, a yaw angle that the heading direction makes with the direction of travel.

3. The system of claim 2, wherein the perception system is further to:
determine, based on the sensing data and using an object detection machine learning model, a type of the object, and wherein selecting the reference yaw angle is further based on the type of the object.

4. The system of claim 1, wherein the sensing data comprises:
one or more camera images of the object,
one or more lidar images of the object, and
one or more radar images of the object; and
wherein to identify the heading direction, the perception system is to process the sensing data using a heading detection machine learning model comprising:
a camera neural network configured to process the one or more camera images of the object and generate a camera feature vector;
a lidar neural network configured to process the one or more lidar images of the object and generate a lidar feature vector;
a lidar neural network configured to process the one or more radar images of the object and generate a radar feature vector; and
a classification neural network configured to output the heading direction of the object, based on the camera feature vector, the lidar feature vector, and the radar feature vector.

5. The system of claim 4, wherein the heading detection machine learning model is further to determine a confidence in the identified heading direction, and wherein the perception system is to cause the control system of the autonomous vehicle to perform the avoidance action responsive to the confidence being above a threshold value.

6. The system of claim 4, wherein to identify the heading direction, the perception system is to process the sensing data using a heading detection machine learning model trained using:
one or more first training inputs associated with a plurality of sensing modalities that comprises two or more of:
a camera modality,
a lidar modality, or
a radar modality; and
one or more second training inputs associated with one or more sensing modalities that lack at least one sensing modality of the plurality of sensing modalities.

7. The system of claim 1, wherein the direction of travel of the object is obtained using at least one of:
a roadgraph data for a portion of a roadway associated with a current location of the object, or
a direction of a traffic lane occupied by the object determined by a computer vision model.

8. The system of claim 1, wherein the sensing system is further configured to collect second sensing data for a second object; and
wherein the perception system is further configured to:
identify a second heading direction for the second object based on the second sensing data;
determine that the second object is at risk of loss of control, based at least on a second difference between the second heading direction and a second direction of travel of the second object; and
abstain, responsive to presence of one or more mitigating conditions, from a second avoidance action, wherein the one or more mitigating conditions comprise at least one of:
a second confidence in the second heading direction being below a threshold value,
a field of view of the second object being at least partially obstructed,
a distance to the second object being above a threshold distance,
the second object being of an exempt object type,
presence of one or more emergency vehicles,
the second object exiting a highway, or
the second object entering the highway.

9. A method comprising:
collecting, using a sensing system of an autonomous vehicle, sensing data for an environment of the autonomous vehicle;
identifying a heading direction of an object in the environment, based at least on the sensing data;
determining that the object is at risk of loss of control of a driving trajectory, based at least on a difference between the heading direction and a direction of travel of the object; and
causing a control system of the autonomous vehicle to perform an avoidance action.

10. The method of claim 9, wherein determining that the object is at risk of loss of control comprises:
selecting, based on a speed of the object, a reference yaw angle for the object; and
comparing, to the reference yaw angle, a yaw angle that the heading direction makes with the direction of travel.

11. The method of claim 10, further comprising:
determining, based on the sensing data and using an object detection machine learning model, a type of the object, and
wherein selecting the reference yaw angle is further based on the type of the object.

12. The method of claim 9, wherein the sensing data comprises:
one or more camera images of the object,
one or more lidar images of the object, and
one or more radar images of the object; and
wherein identifying the heading direction comprises processing the sensing data using a heading detection machine learning model that comprises:
a camera neural network configured to process the one or more camera images of the object and generate a camera feature vector;
a lidar neural network configured to process the one or more lidar images of the object and generate a lidar feature vector;
a lidar neural network configured to process the one or more radar images of the object and generate a radar feature vector; and
a classification neural network configured to process the camera feature vector, the lidar feature vector, and the radar feature vector and output the heading direction of the object.

13. The method of claim 12, wherein processing the sensing data using the heading detection machine learning model comprises determining a confidence in the heading direction; and
wherein causing the control system of the autonomous vehicle to perform the avoidance action is responsive to the confidence being above a threshold value.

14. The method of claim 12, wherein processing the sensing data using a heading detection machine learning model trained using:
one or more first training inputs associated with a plurality of sensing modalities that comprises two or more of:
a camera modality,
a lidar modality, or
a radar modality,
one or more second training inputs associated with one or more sensing modalities that lack at least one sensing modality of the plurality of sensing modalities.

15. The method of claim 9, further comprising:
determining the direction of travel of the object using at least one of:
a roadgraph data for a portion of a roadway associated with a current location of the object, or
a direction of a traffic lane occupied by the object determined by a computer vision model.

16. The method of claim 9, further comprising:
collecting second sensing data for a second object;
identifying a second heading direction for the second object based on the second sensing data;
determining that the second object is at risk of loss of control, based at least on a second difference between the second heading direction and a second direction of travel of the second object; and
abstaining, responsive to presence of one or more mitigating conditions, from a second avoidance action;
wherein the one or more mitigating conditions comprise:
a second confidence in the second heading direction being below a threshold value,
a field of view of the second object being at least partially obstructed,
a distance to the second object being above a threshold distance,
the second object being of an exempt object type,
presence of one or more emergency vehicles,
the second object exiting a highway, or
the second object entering the highway.

17. An autonomous vehicle comprising:
a sensing system configured to acquire sensing data of a plurality of sensing modalities, wherein the plurality of sensing modalities comprises at least two of a camera sensing modality, a radar sensing modality, or a radar sensing modality;
a perception system configured to:
identify a heading direction of an object in an environment of the autonomous vehicle, based at least on processing of the sensing data by a heading detection machine learning model;
determine that the object is at risk of loss of control of a driving trajectory, based at least on a difference between the heading direction and a direction of travel of the object; and
select an avoidance action; and
a driving control system configured to perform the selected avoidance action.

18. The autonomous vehicle of claim 17, wherein to determine that the object is at risk of loss of control, the perception system is configured to:
select, based on a speed of the object, a reference yaw angle for the object; and
compare, to the reference yaw angle, a yaw angle that the heading direction makes with the direction of travel.

19. The autonomous vehicle of claim 18, wherein the perception system is further to:
determine, based on the sensing data and using an object detection machine learning model, a type of the object, and wherein selecting the reference yaw angle is further based on the type of the object.

20. The autonomous vehicle of claim 17, wherein the direction of travel of the object is obtained using at least one of:
a roadgraph data for a portion of a roadway associated with a current location of the object, or
a direction of a traffic lane occupied by the object determined by a computer vision MLM.
